(19) United States
(12) Patent Application Publication
(10) Pub. No.: US 2023/0244241 A1
(43) Pub. Date: Aug. 3, 2023

(54) Method for Operating an Autonomous Mobile Processing Robot and Processing System

(71) Applicant: Andreas Stihl AG & Co. KG, Waiblingen (DE)

(72) Inventor: Stephanie ALTENBURG, Stuttgart (DE)

(21) Appl. No.: 18/103,050

(22) Filed: Jan. 30, 2023

(30) Foreign Application Priority Data
Jan. 31, 2022 (EP) 22154284.8

(51) Int. Cl. G05D 1/02; A01D 34/00; G06T 7/90; G05D 1/00

(52) U.S. Cl. CPC G05D 1/0231; A01D 34/008; G06T 7/90; G05D 1/0088; G06T 2207/30252; G05D 2201/0208

(57) ABSTRACT

A method for operating an autonomous mobile processing robot includes the following steps: a) acquiring an item of color information about a color of an object by use of a color measuring principle and acquiring an item of chlorophyll information about a chlorophyll content of the object by use of a chlorophyll measuring principle independently of the color measuring principle, b) determining a control type from a set of different control types of the processing robot based on at least the acquired color information and the acquired chlorophyll information, and c) controlling the processing robot according to the determined control type.

### CROSS REFERENCE TO RELATED APPLICATION

This application claims priority under 35 U.S.C. § 119 from European Patent Application No. 22154284.8, filed Jan. 31, 2022, the entire disclosure of which is herein expressly incorporated by reference.

### BACKGROUND AND SUMMARY

The invention relates to a method for operating an autonomous mobile processing robot and a processing system.

The invention is based on the problem of providing a method for operating an autonomous mobile processing robot and a processing system, which each have improved properties.

The invention solves this problem by providing a method and a processing system having the features of the independent claims. Advantageous refinements and/or embodiments of the invention are described in the dependent claims.

The method according to the invention is designed or provided for operating an autonomous mobile processing robot. The method includes the following steps: a) acquiring an item of color information, in particular a content of the color information, about a color, in particular a value of the color and/or the color, of an object by means of a color measuring principle, acquiring an item of chlorophyll information, in particular a content of the chlorophyll information, about a chlorophyll content, in particular a value of the chlorophyll content and/or the chlorophyll content, of the object by means of a chlorophyll measuring principle independent of the color measuring principle; b) determining a control type from a set of different control types of the processing robot, in particular in dependence on the acquisition of the object, based on at least the acquired color information and the acquired chlorophyll information; c) controlling the processing robot in the determined control type.

This enables, in particular the color information and the chlorophyll information each enable, a simple and therefore in particular cost-effective acquisition in each case, in particular in contrast to a complex acquisition not according to the invention, in particular of either the color information or the chlorophyll information. Additionally or alternatively, this enables, in particular the color information and the chlorophyll information or the color measuring principle and the chlorophyll measuring principle independently of one another enable, an improved determination of the control type. This furthermore additionally or alternatively enables, in particular the control in the determined control type, an improved interaction of the processing robot with the object.

In particular, the method, the operation, the acquisition, the determination, and/or the control can be automatic. Additionally or alternatively, the acquisition can be contactless or contact-free.

The term “configured” can be used synonymously for the term “designed”. Additionally or alternatively, the term “comprises” or “has” can be used synonymously for the term “includes”.

The processing robot can be electrical and/or controllable. Additionally or alternatively, the processing robot can be designed for autonomous processing of a surface, in particular can include a processing tool. In particular, autonomous processing can mean that the processing robot can move and/or act on the surface in an independent, automatic, self-determined, self-controlled manner and/or independently of a user, in particular a human user, and/or can select at least one parameter, in particular a route parameter, and/or a reversal point. Additionally or alternatively, autonomous processing can mean that the processing robot can begin independently with processing and/or can end the processing. Furthermore, alternatively or additionally, the processing robot does not need to be or is not able to be controlled by the user, in particular remote-controlled, during the automatic processing. In other words: during the autonomous processing, the processing robot can work without human control and/or guidance. Furthermore, alternatively or additionally, the processing robot can be designated as a service robot and/or service provision robot. Furthermore, additionally or alternatively, the processing robot can be a green space processing robot. Furthermore, additionally or alternatively, the surface can be, for example, an exposed surface, in particular unsealed soil, or a green surface, such as a meadow having lawn.

The object can potentially be touched by the processing robot.

The color measuring principle and/or the chlorophyll measuring principle can be contactless or contact-free. Additionally or alternatively, the color measuring principle and/or the chlorophyll measuring principle can be different. Furthermore, additionally or alternatively, the term “action principle” can be used synonymously for the term “measuring principle”. Furthermore, additionally or alternatively, the term “complementary” can be used synonymously for the term “independently”.

The color can be light of electromagnetic radiation of the wavelength between 380 nm (nanometer) and 780 nm. Additionally or alternatively, the color can be a physical color or object color. In other words: the object can be a non-self-luminous object.

The term “select” can be used synonymously for the term “determine”. Additionally or alternatively, the set can include at least two control types. Furthermore, additionally or alternatively, the set of different control types of the processing robot can be considering and/or possibly relating to the object. Furthermore, additionally or alternatively, the determination can be by means of linking or fusing or combining at least the acquired color information and the acquired chlorophyll information.

The word component “supervise”, in particular “regulate”, can be used synonymously for the word component “control”. Additionally or alternatively, the processing robot can be controlled at a point in time in either one control type or another or only a single control type.

Step a) can be executed repeatedly and/or continuously, in particular multiple times.

Step b) can be executed after step a) with respect to time and/or can be executed repeatedly and/or continuously, in particular multiple times.

Step c) can be executed after step b) with respect to time and/or can be executed repeatedly and/or continuously, in particular multiple times.

In one refinement of the invention, step a) includes: acquiring an item of temperature information, in particular a content of the temperature information, about a temperature, in particular a value of the temperature and/or the temperature, of the object by means of a temperature measuring principle, in particular independently of the color measuring principle and/or the chlorophyll measuring principle. Step b) includes: determining the control type based on the acquired temperature information. This enables a simple acquisition. Additionally or alternatively, this enables a further improved determination of the control type. Furthermore, additionally or alternatively, this enables a further improved interaction of the processing robot with the object. In particular, the acquisition can be automatic. Additionally or alternatively, the temperature measuring principle can be contactless or contact-free. Furthermore, additionally or alternatively, the temperature measuring principle can be different from the color measuring principle and/or the chlorophyll measuring principle.

In one refinement, in particular one embodiment, of the invention, the color measuring principle is based on a selective acquisition and assessment of the visible spectral range and/or a supply of color values and/or a tri stimulus principle, in particular by means of a color sensor. Additionally or alternatively, the chlorophyll measuring principle is based on a measurement of chlorophyll fluorescence, in particular by means of a chlorophyll fluorometer. Furthermore, additionally or alternatively, the temperature measuring principle is based on a measurement of thermal radiation, in particular in the infrared, in particular the middle infrared, in particular by means of a pyrometer. In particular, the color sensor, the chlorophyll fluorometer, and/or the pyrometer can be electric. Additionally or alternatively, the color sensor can be an RGB sensor. Furthermore, additionally or alternatively, the pyrometer can be a quotient pyrometer. Moreover, reference is made to the technical literature.

In one embodiment of the invention, the measurement of chlorophyll fluorescence includes: emitting electromagnetic radiation, which is in particular modulated, in particular pulsed, in particular of only one first wavelength, in particular one single first wavelength, in particular 432 nm; receiving electromagnetic radiation, which is in particular modulated, in particular pulsed, of a second wavelength greater than the first, in particular of 630 nm to 1100 nm, in particular about 700 nm, in particular excited by the emitted radiation. This enables a particularly simple acquisition, in particular in the event of external light and/or ambient light and/or sunlight and/or of chlorophyll a. In particular, the emitting and/or receiving can be automatic. Additionally or alternatively, the emitting can be executed repeatedly and/or continuously, in particular multiple times. Furthermore, additionally or alternatively, the receiving can be executed after the emitting with respect to time and/or can be executed repeatedly and/or continuously, in particular multiple times. Furthermore, additionally or alternatively, electromagnetic radiation of a, in particular the, range of the second wavelength greater than the first, in particular of 630 nm to 1100 nm, in particular about 700 nm, can be received or measured. In other words: electromagnetic radiation of only a single second wavelength does not have to or is not able to be received or measured. Furthermore, additionally or alternatively, electromagnetic radiation of a further wavelength does not have to or is not able to be emitted and/or received. In particular, the method including the acquisition of the chlorophyll information by means of the chlorophyll measuring principle underlying the measurement of chlorophyll fluorescence including the emission of the electromagnetic radiation of only the single first wavelength and/or the reception of the electromagnetic radiation of the range of the second wavelength greater than the first, in particular by means of such a simple chlorophyll fluorometer, and/or the acquisition of the color information and, in particular thus, the determination of the control type based on, in particular only on, the acquired chlorophyll information and/or not based on an item of color information can represent an independent invention. Furthermore, additionally or alternatively, about 700 nm can mean ±10 nm. Moreover, reference is made to the technical literature.

In one refinement, in particular one embodiment, of the invention, step b) includes: determining the control type based on whether the acquired color information or an item of information based on the color information, which is in particular acquired, meets a color criterion or not. The color criterion is characteristic for the color green, in particular the color is green; additionally or alternatively, determining the control type based on whether the acquired chlorophyll information or an item of information based on the chlorophyll information, which is in particular acquired, meets a chlorophyll criterion or not. The chlorophyll criterion is characteristic for a chlorophyll minimum content, in particular is the chlorophyll minimum content; furthermore, additionally or alternatively, determining the control type based on whether the acquired temperature information or an item of information based on the temperature information, which is in particular acquired, meets a temperature criterion or not. The temperature criterion is characteristic for a minimum temperature, in particular 35° C. (degrees Celsius), in particular is the minimum temperature. This enables a particularly good determination of the control type, in particular taking into consideration the object as grass and/or a plant, e.g., moss, a thing, e.g., a rock or plastic and/or a toy, animal, or human. In particular, the term “identifying” can be used synonymously for the term “characteristic”. Additionally or alternatively, a criterion, in particular a respective criterion, can be characteristic for a minimum value. In particular, the optimum minimum value, in particular the respective optimum minimum value, can be found by methods of machine learning. Moreover, reference is made to the technical literature.

In one embodiment of the invention, step b) includes: determining the control type taking into consideration the object as grass and/or a plant if the color criterion is met and if the chlorophyll criterion is met, in particular in a sun/shade transition if the temperature criterion is met; additionally or alternatively determining the control type taking into consideration the object as a green-colored thing or green-colored animal or green-colored human or having a green-colored feature if the color criterion is met and the chlorophyll criterion is not met, in particular as a thing if the temperature criterion is not met or as an animal or human if the temperature criterion is met; furthermore, additionally or alternatively, determining the control type taking into consideration the object as a chlorophyll-including thing or chlorophyll-including animal or chlorophyll-including human if the color criterion is not met and if the chlorophyll criterion is met, in particular as a thing if the temperature criterion is not met or as an animal or human if the temperature criterion is met; furthermore, additionally or alternatively, determining the control type taking into consideration the object as a thing or animal or human if the color criterion is not met and if the chlorophyll criterion is not met, in particular as a thing if the temperature criterion is not met or as an animal or human if the temperature criterion is met. This, in particular the control in the determined control type, enables a particularly good interaction of the processing robot with the object. In particular, the term “chlorophyll-containing” can be used synonymously for the term “chlorophyll-including”.

In one refinement, in particular one embodiment, of the invention, step b) includes: determining the control type from the set of different control types including at least one processing control type and one non-processing control type, in particular as the processing control type if the color criterion is met and if the chlorophyll criterion is met and/or as the non-processing control type if the color criterion is not met and/or the chlorophyll criterion is not met. This enables a specific interaction, in particular specific by nature or type, with the object, in particular enabling or permitting a touch of the object by the processing robot, in particular in the processing control type, or avoiding or blocking such a touch, in particular in the non-processing control type. In particular, the processing control type and the non-processing control type can be different.

In one refinement, in particular one embodiment, of the invention, the processing robot includes a movement drive system, in particular a traction drive system, for moving the processing robot on a surface, in particular the surface. Step c) includes: controlling the movement drive system in the determined control type, in particular in the processing control type for moving the processing robot to the object, in particular over the object and/or in contact with the object, or in the non-processing control type for moving the processing robot around the object. Additionally or alternatively, the processing robot has a movable processing tool, in particular the processing tool, for processing a surface, in particular the surface, and a tool drive system for moving the processing tool. Step c) includes: controlling the tool drive system in the determined control type, in particular in the processing control type activating the tool drive system to process the object or in the non-processing control type deactivating the tool drive system to not process the object. In particular, the surface can be processed by the processing robot, in particular its processing tool. Additionally or alternatively, the object, can be or rest in particular either on a part of the surface or on the surface. Furthermore, additionally or alternatively, the movement drive system and/or the tool drive system can be a motor drive system, electrical and/or controllable. Furthermore, alternatively or additionally, the term “switch on” can be used synonymously for the term “activate”. Furthermore, additionally or alternatively, the term “switch off” can be used synonymously for the term “deactivate”.

In one refinement, in particular one embodiment, of the invention, the processing robot includes, in particular on its lower side, a processing tool, in particular the processing tool for processing a surface, in particular the surface. The processing tool, in particular at least one end of the processing tool, defines or includes a processing region. Step a) includes: acquiring the color information about the color and/or the chlorophyll information about the chlorophyll content of the object in an acquisition region. The acquisition region is or lies outside the processing region, in particular in front of the processing region, in particular the processing robot. This enables the acquisition and thus the determination and the control to be able to be timely, in particular before a potential touch of the object by the processing robot with respect to time. In particular, the surface can be intended to be processed by the processing robot, in particular its processing tool. Additionally or alternatively, the object can, in particular either, be or lie on a part of the surface or on the surface. Furthermore, additionally or alternatively, the temperature information about the temperature of the object can be acquired in the acquisition region. Furthermore, additionally or alternatively, the acquisition region and the processing region can be different and/or three-dimensional, in particular completely, in particular on the surface. Furthermore, additionally or alternatively, the acquisition region can be at least 5 cm (centimeter), in particular 10 to 15 cm, in front of the processing region, in particular the processing robot. Furthermore, additionally or alternatively, in front can be in a preferred or main movement direction of the processing robot.

In one refinement of the invention, the processing robot is designed as a lawnmower robot, in particular having a lawnmowing tool. The method can be particularly advantageous for such a processing robot. In particular, the processing robot can be designed as a mulching mower robot. Additionally or alternatively, the lawnmowing tool can comprise at least one mowing string, at least one plastic cutter, at least one metal cutter and/or a metal cutting blade having at least one cutting edge and/or having at least one cutting tooth. Furthermore, additionally or alternatively, the lawnmowing tool can be designed as a rotating lawnmowing tool and for the purpose of mowing a material to be mowed in the so-called free cutting method without counter blade.

In one refinement, in particular one embodiment, of the invention, the acquisition of the color information and/or the chlorophyll information and/or the temperature information is executed by means of the processing robot, in particular downward, in particular directed. This enables the acquisition at a point where the object can be.

The processing system according to the invention includes an acquisition device, a determination device, and a control device. The acquisition device is designed for acquisition, in particular the acquisition, of an item of color information, in particular the item of color information, about a color, in particular the color of an object, in particular the object, by means of a color measuring principle, in particular the color measuring principle, and designed for acquisition, in particular the acquisition, of an item of chlorophyll information, in particular the item of chlorophyll information, about a chlorophyll content, in particular the chlorophyll content, of the object by means of a chlorophyll measuring principle, in particular the chlorophyll measuring principle, independently of the color measuring principle. The determination unit is designed for determination, in particular the determination, of a control type, in particular the control type, from a set, in particular the set, of different control types of an autonomous mobile processing robot, in particular the autonomous mobile processing robot, based on at least the acquired color information and the acquired chlorophyll information. The control device is designed for control, in particular the control, of the processing robot in the determined control type. The processing system can enable at least a part or even all advantages as mentioned above for the method. In particular, the processing system can be designed for the execution, in particular automatic execution, of a method, in particular the method, as mentioned above. Additionally or alternatively, the processing system can be a green space processing system. Furthermore, additionally or alternatively, the processing system, the acquisition device, the determination device, and/or the control device can be electrical. Furthermore, additionally or alternatively, the term “sensor device” can be used synonymously for the term “acquisition device”. Furthermore, additionally or alternatively, the acquisition device can define or include the acquisition region. Furthermore, additionally or alternatively, the determination device and/or the control device can include, in particular can be, a computing device and/or a microcontroller and/or a computer.

In one refinement of the invention, the processing system includes the processing robot.

In one refinement of the invention, the processing robot includes the acquisition device and/or the determination device and/or the control device.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a processing system according to an embodiment of the invention including an autonomous mobile processing robot and an exemplary method for operating the autonomous mobile processing robot, and in particular schematically shows a diagram for acquiring an item of temperature information about a temperature of an object by means of the processing system and the method.

FIG. 2 schematically shows the processing system and the method of FIG. 1.

FIG. 3 schematically shows a diagram of chlorophyll fluorescence of an object for acquiring an item of chlorophyll information or chlorophyll content of the object by means of the processing system and the method of FIG. 1.

FIG. 4 schematically shows a further diagram of chlorophyll fluorescence of an object for acquiring an item of chlorophyll information of an item of chlorophyll information about a chlorophyll content of the object by means of the processing system and the method of FIG. 1.

FIG. 5 schematically shows a diagram for acquiring an item of color information about a color of an object by means of the processing system and the method of FIG. 1.

FIG. 6 schematically shows a determination tree of the processing system and the method of FIG. 1.

### DETAILED DESCRIPTION OF THE DRAWINGS

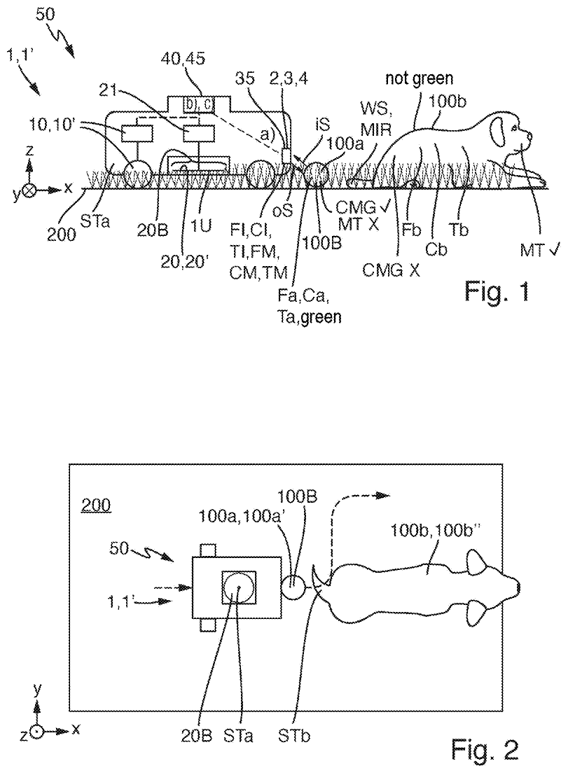

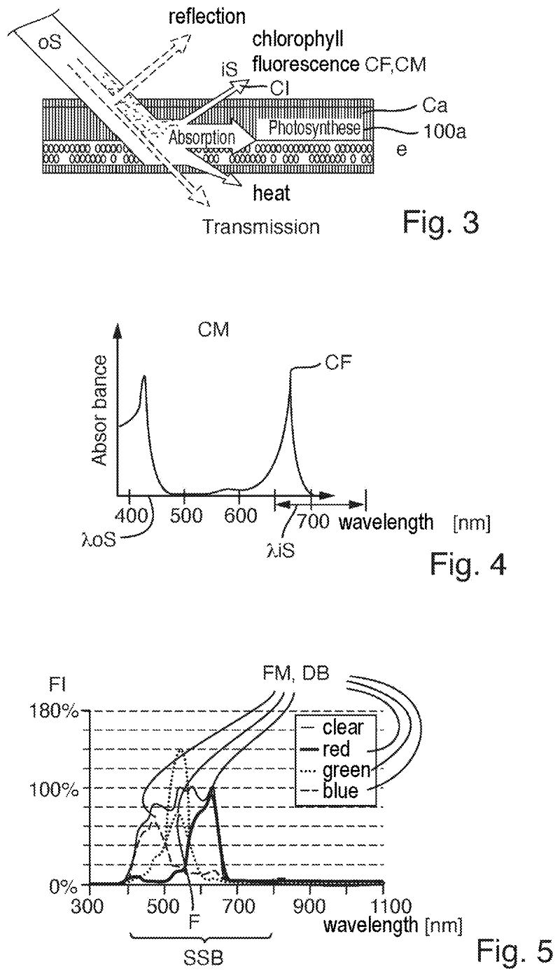

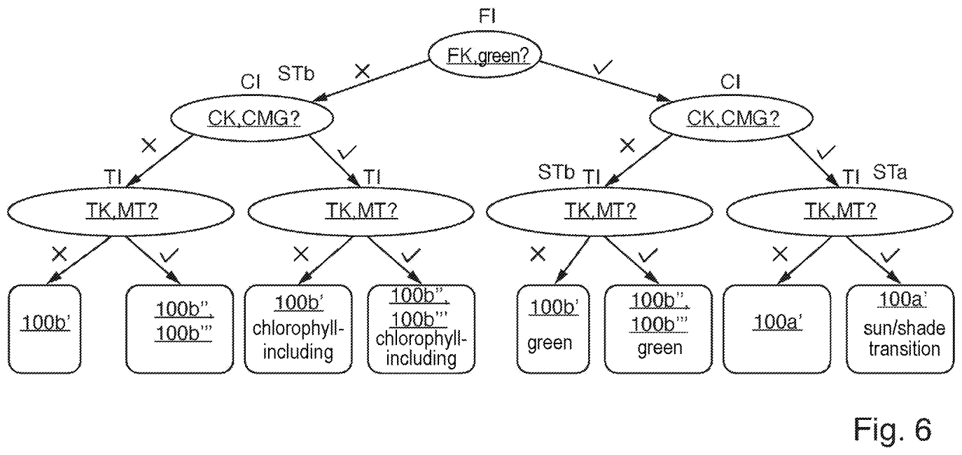

FIGS. 1 and 2 show a processing system 50. The processing system 15 includes an acquisition device 35, a determination device 40, and a control device 45. The acquisition device 35 is designed to acquire an item of color information FI about a color Fa, Fb of an object 100a, 100b by means of a color measuring principle FM, as shown in FIG. 5, and to acquire an item of chlorophyll information CI about a chlorophyll content Ca, Cb of the object 100a, 100b by means of a chlorophyll measuring principle CM, as shown in FIGS. 3 and 4, designed independently of the color measuring principle FM, in particular acquired. The determination device 40 is designed to determine a control type STa, STb from a set of various control types STa, STb of an autonomous mobile processing robot 1 based on at least the acquired color information FI and the acquired chlorophyll information CI, in particular determined, as shown in FIG. 6. The control device 45 is designed to control the processing robot 1 in the determined control type STa, STb, in particular controlled.

In detail, the processing system 50 includes the processing robot 1.

Furthermore, the processing robot 1 includes the acquisition device 35 and/or the determination device 40 and/or the control device 45.

FIGS. 1 to 6 show a method for operating the autonomous mobile processing robot 1, in particular by means of the processing system 50. The method includes the following steps: a) acquiring the color information FI about the color Fa, Fb of the object 100a, 100b by means of the color measuring principle FM, in particular by means of the acquisition device 35; acquiring the chlorophyll information CI about the chlorophyll content Ca, Cb of the object 100a, 100b by means of the chlorophyll measuring principle CM independently of the color measuring principle FM, in particular by means of the acquisition device 35; b) determining the control type STa, STb from the set of different control types STa, STb of the processing robot 1 based on at least the acquired color information FI and the acquired chlorophyll information CI, in particular by means of the determination device 40; c) controlling the processing robot 1 in the determined control type STa, STb, in particular by means of the control device 45.

In addition, step a) includes: acquiring an item of temperature information TI about a temperature Ta, Tb of the object 100a, 100b by means of a temperature measuring principle TM, as shown in FIG. 1, in particular independently of the color measuring principle FM and/or the chlorophyll measuring principle CM, in particular by means of the acquisition device 35. Step b) includes: determining the control type STa, STb based on the acquired temperature information TI, in particular by means of the determination device 40.

Furthermore, the acquisition of the color information FI and/or the chlorophyll information CI and/or the temperature information TI is executed by means of the processing robot 1.

In detail, the color measuring principle FM is based on a selective acquisition and assessment of the visible spectral range SSB and/or a supply of color values and/or a tristimulus principle DB, as shown in FIG. 5, in particular by means of a color sensor 2, as shown in FIG. 1. Additionally or alternatively, the chlorophyll measuring principle CM is based on a measurement of chlorophyll florescence CF, as shown in FIGS. 3 and 4, in particular by means of a chlorophyll fluorometer 3, as shown in FIG. 1. Furthermore, additionally or alternatively, the temperature measuring principle TM is based on a measurement of thermal radiation WS, in particular in the infrared, in particular the middle infrared MIR, in particular by means of a pyrometer 4, as shown in FIG. 1.

In the exemplary embodiment shown, the acquisition device 35 includes the color sensor 2 and/or the chlorophyll fluorometer 3 and/or the pyrometer 4.

Moreover, the color sensor 2 is an RGB sensor or has 3 color channels, as shown in FIG. 5. In particular, a measurement of the color channels with white underlying surface provides a zero line. Furthermore, the 3 color channels are combined to determine or decide whether the acquired color is green, in particular if there is a significant increase of the green color channel or spectrum in comparison to the other color channels or spectra.

In detail, the measurement of chlorophyll fluorescence CF includes: emitting electromagnetic radiation oS, which is in particular modulated, in particular pulsed, in particular only one first wavelength, in particular one single first wavelength λoS, in particular 432 nm, as shown in FIGS. 1, 3, and 4, in particular by means of the chlorophyll fluorometer 3; receiving electromagnetic radiation iS, which is in particular modulated, in particular pulsed, of a second wavelength λiS, greater than the first, in particular of 630 nm to 1100 nm, in particular about 700 nm, in particular by means of the chlorophyll fluorometer 3.

In particular, the emitted radiation oS excites chlorophyll e, if present. The excited chlorophyll e emits the received radiation iS, in particular back to the chlorophyll fluorometer 3.

Moreover, the chlorophyll fluorometer 3 includes at least one emitting device, for example a photodiode, for emitting the radiation oS and/or at least one receiving device, for example a phototransistor, for receiving the radiation iS.

Furthermore, step b) includes: determining the control type STa, STb based on whether the acquired color information FI or an item of information based on the color information meets a color criterion FK or not, as shown in FIG. 6. The color criterion FK is characteristic for the color green; additionally or alternatively, determining the control type STa, STb based on whether the acquired chlorophyll information CI or an item of information based on the chlorophyll information meets a chlorophyll criterion CK or not. The chlorophyll criterion CK is characteristic for a chlorophyll minimum content CMG; furthermore, additionally or alternatively, determining the control type STa, STb based on whether the acquired temperature information TI or an item of information based on the temperature information meets the temperature criterion TK or not. The temperature criterion CK is characteristic for a minimum temperature MT, in particular 35° C.

In detail, step b) includes: determining the control type STa considering the object 100a as grass 100a′ and/or a plant if the color criterion FK is met and if the chlorophyll criterion CK is met, in particular in a sun/shade transition if the temperature criterion TK is met. Additionally or alternatively, determining the control type STb considering the object 100b as a green-colored thing 100b′ or green-colored animal 100b″ or green-colored human 100b′″ if the color criterion FK is met and if the chlorophyll criterion CK is not met, in particular as a thing 100b′ if the temperature criterion TK is not met or as an animal 100b″ or human 100b′″ if the temperature criterion TK is met; furthermore, additionally or alternatively, determining the control type STb considering the object 100b as a chlorophyll-including thing 100b″′ or chlorophyll-including animal 100b″ or chlorophyll-including human 100b′″ if the color criterion FK is not met and if the chlorophyll criterion CK is met, in particular as a thing 100b′ if the temperature criterion TK is not met or as an animal 100b″ or human 100b′″ if the temperature criterion TK is met; furthermore, additionally or alternatively, determining the control type STb considering the object 100b as a thing 100b′ or animal 100b″ or human 100b″′ if the color criterion FK is not met and if the chlorophyll criterion CK is not met, in particular as a thing 100b′ if the temperature criterion TK is not met or as an animal 100b″ or human 100b′″ if the temperature criterion TK is met.

In the exemplary embodiment shown, the object 100a is grass 100a′ and/or the object 100b is an animal 100b″, for example a dog, as shown in FIGS. 1 and 2.

Moreover, the object 100a is a part of a surface 200. Additionally or alternatively, the object 100b is on the surface 200.

Furthermore, step b) includes: determining the control type STa, STb from the set of different control types STa, STb including at least one processing control type STa and one non-processing control type STb, in particular as the processing control type STa if the color criterion FK is met and if the chlorophyll criterion CK is met and/or as the non-processing control type STb if the color criterion FK is not met and/or if the chlorophyll criterion CK is not met, as shown in FIG. 6.

In addition, the processing robot 1 has a movement drive system 10, in particular a traction drive system 10′, for moving the processing robot 1 on the surface 200, as shown in FIG. 1. Step c) includes: controlling the movement drive system 10 in the determined control type STa, STb, in particular in the processing control type STa to move the processing robot 1 to the object 100a or in the non-processing control type STb to move the processing robot 1 around the object 100b, as shown in FIG. 2. Additionally or alternatively, the processing robot 1 has a movable processing tool 20 for processing the surface 200 and a tool drive system 21 for moving the processing tool 20, as shown in FIG. 1. Step c) includes: controlling the tool drive system 21 in the determined control type STa, STb, in particular in the processing control type STa activating the tool drive system 21 for processing the object 100a or in the non-processing control type STb deactivating the tool drive system 21 for not processing the object 100b.

Furthermore, the processing robot 1 includes, in particular on its lower side 1U, the processing tool 20 for processing the surface 200. The processing tool 20 defines a processing region 20B. Step a) includes: acquiring the color information FI about the color Fa, Fb and/or the chlorophyll information CI about the chlorophyll content Ca, Cb, and in particular the temperature information TI about the temperature Ta, Tb, of the object 100a, 100b in an acquisition region 100B. The acquisition region 100B is outside the processing region 20B, in particular in front of the processing region 20B, in particular the processing robot 1.

Moreover, the processing robot 1 is designed as a lawnmower robot 1′, in particular having a lawnmowing tool 20′, in particular mows.

In the exemplary embodiment shown, the processing tool 20 is the lawnmowing tool 20′.

Furthermore, the color information FI about the color Fa and the chlorophyll information CI about the chlorophyll content Ca of the object 100a are acquired first with respect to time, and in particular not the color information FI about the color Fb and the chlorophyll information CI about the chlorophyll content Cb of the object 100b, as shown in FIGS. 1 and 2. The object 100a is the grass 100a′. The acquired color information FI thus meets the color criterion FK and the acquired chlorophyll information CI meets the chlorophyll criterion CK. The control type STa, in particular the processing control type STa, is thus determined and the processing robot 1 is controlled in the determined control type STa, in particular the processing control type STa.

Second with respect to time or thereafter, the color information FI about the color Fb and the chlorophyll information CI about the chlorophyll content Cb of the object 100b are acquired, and in particular not the color information FI about the color Fa and the chlorophyll information CI about the chlorophyll content Ca of the object 100a. The object 100b is the animal 100b″. The acquired color information FI therefore does not meet the color criterion FK and/or the acquired chlorophyll information CI does not meet the chlorophyll criterion CK. The control type STb, in particular the non-processing control type STb, is thus determined and the processing robot 1 is controlled in the determined control type STb, in particular the non-processing control type STb.

As the exemplary embodiments shown and explained above make clear, the invention provides an advantageous method for operating an autonomous mobile processing robot and an advantageous processing system, which each have improved properties.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating an autonomous mobile processing robot, the method comprising the steps of:
a) acquiring an item of color information about a color of an object by use of a color measuring principle and acquiring an item of chlorophyll information about a chlorophyll content of the object by use of a chlorophyll measuring principle independently of the color measuring principle;
b) determining a control type from a set of different control types of the processing robot based on at least the acquired color information and the acquired chlorophyll information; and
c) controlling the processing robot according to the determined control type.

2. The method according to claim 1,
wherein step a) includes: acquiring an item of temperature information about a temperature of the object by use of a temperature measuring principle, and
wherein step b) includes: determining the control type based on the acquired temperature information.

3. The method according to claim 2, wherein
the temperature measuring principle is independent of the color measuring principle and/or the chlorophyll measuring principle, and
the temperature measuring principle is based on a measurement of infrared thermal radiation.

4. The method according to claim 1,
wherein the color measuring principle is based on a selective acquisition and assessment of a visible spectral range and/or a supply of color values and/or a tristimulus principle, via a color sensor.

5. The method according to claim 1,
wherein the chlorophyll measuring principle is based on a measurement of chlorophyll fluorescence, via a chlorophyll fluorometer.

6. The method according to claim 5, wherein the measurement of chlorophyll fluorescence comprises:
emitting electromagnetic radiation, wherein the emitted electromagnetic radiation is one of: modulated, pulsed, of only one first wavelength, or 432 nm; and
receiving electromagnetic radiation, wherein the received electromagnetic radiation is one of: modulated, pulsed, of a second wavelength greater than the first wavelength, 630 nm to 1100 nm, or approximately 700 nm.

7. The method according to claim 2, wherein step b) comprises determining the control type based on:
whether the acquired color information or an item of information based on the color information meets a color criterion or not, wherein the color criterion is characteristic for a green color, and/or
whether the acquired chlorophyll information or an item of information based on the chlorophyll information meets a chlorophyll criterion or not, wherein the chlorophyll criterion is characteristic for a chlorophyll minimum content, and/or
whether the acquired temperature information or an item of information based on the temperature information meets a temperature criterion or not, wherein the temperature criterion is characteristic for a minimum temperature.

8. The method according to claim 2, wherein step b) comprises determining the control type considering the object as:
grass and/or a plant if the color criterion is met and if the chlorophyll criterion is met, and as grass and/or a plant in a sun/shade transition if the temperature criterion is additionally met, and/or
a green-colored thing or green-colored animal or green-colored human if the color criterion is met and if the chlorophyll criterion is not met, and as a thing if the temperature criterion is not additionally met or as an animal or human if the temperature criterion is additionally met, and/or
a chlorophyll-including thing or chlorophyll-including animal or chlorophyll-including human if the color criterion is not met and if the chlorophyll criterion is met, and as a thing if the temperature criterion is additionally not met or as an animal or human if the temperature criterion is additionally met, and/or
a thing or animal or human if the color criterion is not met and if the chlorophyll criterion is not met, and as a thing if the temperature criterion is not additionally met or as an animal or human if the temperature criterion is additionally met.

9. The method according to claim 7,
wherein step b) comprises: determining the control type from the set of different control types including at least one processing control type and one non-processing control type,
wherein the processing control type is determined if the color criterion is met and if the chlorophyll criterion is met, and/or wherein the non-processing control type is determined if the color criterion is not met and/or if the chlorophyll criterion is not met.

10. The method according to claim 9,
wherein the processing robot comprises a movement drive system for moving the processing robot on a surface, and wherein step c) comprises: controlling the movement drive system according to the processing control type to move the processing robot to the object or according to the non-processing control type to move the processing robot around the object, and/or
wherein the processing robot comprises a movable processing tool for processing a surface and a tool drive system for moving the processing tool, and wherein step c) comprises:
controlling the tool drive system according to the processing control type activating the tool drive system to process the object or according to the non-processing control type deactivating the tool drive system to not process the object.

11. The method according to claim 1,
wherein the processing robot comprises a processing tool for processing a surface, wherein the processing tool defines a processing region, and
wherein step a) comprises: acquiring the color information about the color and/or the chlorophyll information about the chlorophyll content of the object in an acquisition region, wherein the acquisition region is outside the processing region.

12. The method according to claim 11, wherein
the acquisition region is in front of the processing region.

13. The method according to claim 1,
wherein the processing robot is a lawnmower robot.

14. The method according to claim 2,
wherein the acquisition of the color information and/or the chlorophyll information and/or the temperature information is executed by the processing robot.

15. A processing system, comprising:
an acquisition device, wherein the acquisition device is designed to acquire an item of color information about a color of an object by use of a color measuring principle and to acquire an item of chlorophyll information about a chlorophyll content of the object by use of a chlorophyll measuring principle independently of the color measuring principle;
a determination device, wherein the determination device is designed to determine a control type from a set of different control types of an autonomous mobile processing robot based on at least the acquired color information and the acquired chlorophyll information; and
a control device, wherein the control device is designed to control the processing robot according to the determined control type.

16. The processing system according to claim 15,
wherein the processing system includes the processing robot.

17. The processing system according to claim 16,
wherein the processing robot includes the acquisition device and/or the determination device and/or the control device.
